(19) United States
(12) Patent Application Publication
(10) Pub. No.: US 2020/0213696 A1
(43) Pub. Date: Jul. 2, 2020

(54) SPEAKER BOX

(71) Applicant: AAC Technologies Pte. Ltd., Singapore City (SG)

(72) Inventor: Chengliang Wang, Shenzhen (CN)

(21) Appl. No.: 16/703,900

(22) Filed: Dec. 5, 2019

(30) Foreign Application Priority Data
Dec. 27, 2018 (CN) 201822226600.6

(51) Int. Cl. H04R 1/02; H04R 1/06

(52) U.S. Cl. CPC H04R 1/025; H04R 1/06

(57) ABSTRACT

The present disclosure provides a speaker box, including a first housing, a second housing, and a speaker unit. The first housing includes a top wall, a first sidewall, and a sound guiding channel. The top wall includes a first inner surface. The speaker unit is mounted on the first inner surface. The second housing includes a bottom wall and a second sidewall. The second sidewall divides the receiving space into a first space and a second space. The speaker unit is received in the first space. The speaker unit includes an FPC, and the FPC is drawn from a gap between the second sidewall and the top wall.

### TECHNICAL FIELD

The present disclosure relates to the field of electroacoustic conversion technology, and in particular, to a speaker box.

### BACKGROUND

With the advent of the mobile Internet era, the number of smart mobile devices continues to rise. Among the numerous mobile devices, mobile phones are undoubtedly the most common and portable mobile terminal devices. At present, functions of the mobile phones are extremely diverse, one of which is high-quality music. Therefore, speaker boxes for playing sound have been widely used in today's smart mobile devices.

In the related art, in order to improve a bass effect of the speaker box, an interior thereof is often filled with a sound absorbing material. However, in the case where an overall size of the speaker box is constant, it is difficult to increase limited internal space to achieve an effect of expanding a virtual sound cavity.

Therefore, it is necessary to provide a new speaker box to solve the above technical problems.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an exploded perspective diagram of a speaker box of Embodiment 1;

FIG. 2 is a cross-sectional diagram of a speaker box of Embodiment 1;

FIG. 3 is an exploded perspective diagram of a speaker box of Embodiment 2;

FIG. 4 is an enlarged diagram of a portion A in FIG. 3; and

FIG. 5 is a perspective diagram of a second housing of a speaker box of Embodiment 2.

### DESCRIPTION OF EMBODIMENTS

The present disclosure will be further illustrated with reference to the accompanying drawings and the embodiments.

### Embodiment 1

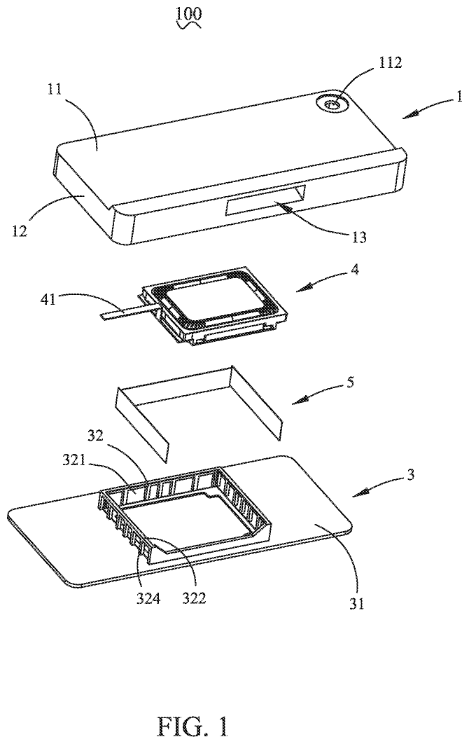

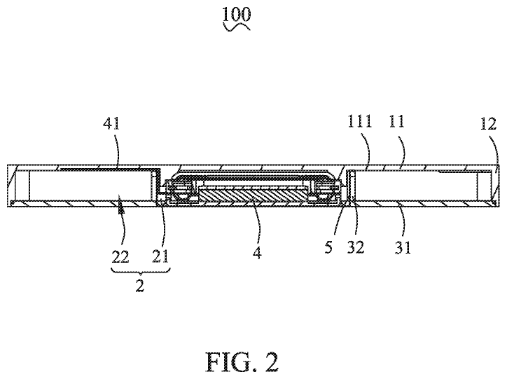

Referring to FIGS. 1 and 2, the present disclosure provides a speaker box 100. The speaker box 100 includes a first housing 1, a second housing 3 assembled with the first housing 1 to define a receiving space 2, and a speaker unit 4 received in the receiving space 2. The first housing 1 and the second housing 3 are fixedly connected by ultrasonic welding or glue sealing. The speaker unit 4 includes an FPC 41 electrically connected to an external circuit. In a specific embodiment of the present disclosure, the FPC 41 extends along an outer side surface of the speaker unit 4 while being bent.

The first housing 1 includes a top wall 11 and a first sidewall 12 extending from a periphery of the top wall 11 towards the second housing 3, and a sound guiding channel 13 extending from the first sidewall 12 towards the speaker unit 4 and communicating with the speaker unit 4. By providing the sound guiding channel 13, the speaker box 100 can emit sound from its sides. The top wall 11 includes a first inner surface 111 facing the receiving space 2, and the speaker unit 4 is mounted on the first inner surface 111.

The second housing 3 includes a bottom wall 31 opposite to and spaced apart from the top wall 11, and a second sidewall 32 extending from the bottom wall 31 towards the top wall 11 and surrounding the speaker unit 4. The second sidewall 32 divides the receiving space 2 into a first space 21 and a second space 22, and the speaker unit 3 is received in the first space 21.

The speaker box 100 further includes a powder filling through hole 112 provided on the top wall 11. The powder filling through hole 112 communicates the second space 22 with outside, and the sound absorbing material is filled into the second space 22 through the powder filling through hole 112.

The second sidewall 32 includes a through hole 321 that communicates the first space 21 with the second space 22. A plurality of through holes 321 is provided, and the plurality of the through holes 321 is arranged in an array along a circumferential direction of the second sidewall 32. Through the through hole 321, the first space 21 and the second space 22 are communicated, so that a rear cavity volume of the speaker unit 4 is increased, and the bass effect is improved.

The speaker box 100 further includes a gas permeable member 5 formed into one piece with the second sidewall 32 and completely covering the through hole 321. In a specific embodiment of the present disclosure, the gas permeable member 5 is provided on an inner side surface of the second sidewall 32 facing the first space 21. The gas permeable member 5 and the second sidewall 32 are formed into one piece by injection molding, hot melting or glue bonding. The FPC 41 is drawn from a gap between the second sidewall 32 and the top wall 11, and the other portion between the second sidewall 32 and the top wall 11 is sealed with a glue, a foam or a double-sided tape.

The second sidewall 32 includes a top frame 322, and a plurality of posts 323 spaced apart from and parallel with each other and connecting the top frame 322 with the bottom wall 31. The gap space between the two adjacent posts 323 is the through hole 321.

### Embodiment 2

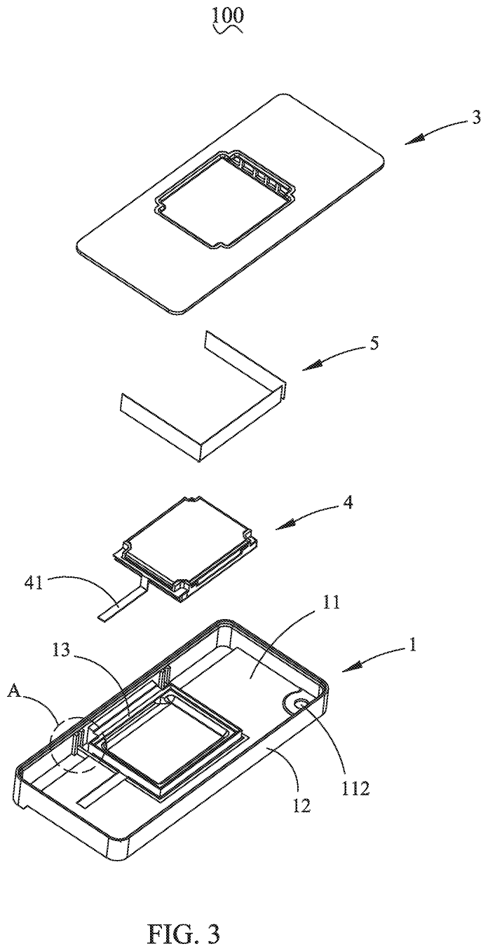

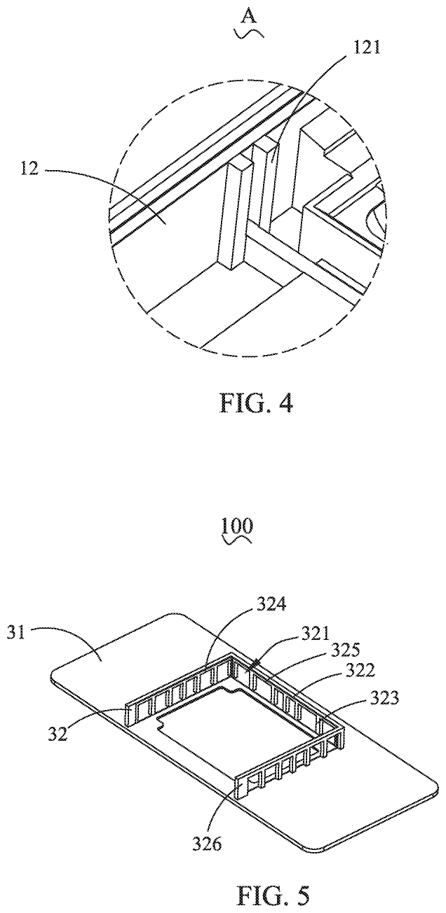

Referring to FIGS. 3-5 together, Embodiment 2 also provides a speaker box 100. A difference between the speaker box 100 in Embodiment 2 and the speaker box 100 in Embodiment 1 lies in that in Embodiment 2, the second sidewall 32 includes a first flank wall 324, a second flank wall 325, and a third flank wall 326. The first flank wall 324 and the third flank wall 326 are in parallel with and apart from each other. The first sidewall 12 includes two slots 121 respectively matching the first flank wall 324 and the third flank wall 326. The second flank wall 325 connects ends the first flank wall 324 and the third flank wall 326 facing away from the slots 121.

When the first housing 1 and the second housing 3 are being assembled, the first flank wall 324 and the third flank wall 326 are inserted into the slots 121, preventing the sound absorbing material in the second space 22 from entering the first space 21, which would otherwise affect the speaker unit 4.

Beneficial effects of the present disclosure are as follows.

1. A volume of the second space can be effectively increased, thereby improving a bass effect of the speaker box.

2. By providing the gas permeable member on the second sidewall, a gas permeable area of the gas permeable member is increased, and a filling effect of the sound absorbing material into the second space is effectively increased.

3. Compared with a plug-in solution, the assembly process is simple, and mass production and reliability are effectively guaranteed.

What has been described above is only an embodiment of the present disclosure, and it should be noted herein that one ordinary person skilled in the art can make improvements without departing from the inventive concept of the present disclosure, but these are all within the scope of the present disclosure.

What is claimed is:

1. A speaker box, comprising:
a first housing;
a second housing assembled with the first housing to define a receiving space;
a speaker unit received in the receiving space; and
a gas permeable member,
wherein the first housing comprises a top wall, a first sidewall extending from a periphery of the top wall towards the second housing, and a sound guiding channel extending from the first sidewall towards the speaker unit and communicating with the speaker unit, the top wall comprises a first inner surface facing the receiving space, and the speaker unit is mounted on the first inner surface,
wherein the second housing comprises a bottom wall opposite to and spaced apart from the top wall, and a second sidewall extending from the bottom wall towards the top wall and surrounding the speaker unit, the second sidewall divides the receiving space into a first space and a second space, the speaker unit is received in the first space, and the second sidewall comprises one or more through holes communicating the first space with the second space,
wherein the gas permeable member and the second sidewall are formed into one piece, and the gas permeable member completely covers the one or more through holes, and
the speaker unit comprises an FPC electrically connected to an external circuit, and the FPC is drawn from a gap between the second sidewall and the top wall.

2. The speaker box as described in claim 1, further comprising a sound absorbing material filled in the second space.

3. The speaker box as described in claim 1, wherein the one or more through holes comprise a plurality of through holes, and the plurality of the through holes is arranged in an array along a circumferential direction of the second sidewall.

4. The speaker box as described in claim 1, wherein the gas permeable member and the second sidewall are formed into one piece by injection molding, hot melting or glue bonding.

5. The speaker box as described in claim 1, wherein the first housing and the second housing are fixedly connected by ultrasonic welding or glue sealing.

6. The speaker box as described in claim 1, further comprising a powder filling through hole provided on the top wall, and the powder filling through hole communicates the second space with outside.

7. The speaker box as described in claim 2, further comprising a powder filling through hole provided on the top wall, and the powder filling through hole communicates the second space with outside.

8. The speaker box as described in claim 1, wherein the second sidewall further comprises a top frame, and a plurality of posts spaced apart from and parallel with each other and connecting the top frame with the bottom wall, and each of the one or more through holes is a gap space between two adjacent ones of the plurality of posts.

9. The speaker box as described in claim 1, wherein the gas permeable member is provided on an inner side surface of the second sidewall facing the first space.

10. The speaker box as described in claim 2, wherein the gas permeable member is provided on an inner side surface of the second sidewall facing the first space.

11. The speaker box as described in claim 3, wherein the gas permeable member is provided on an inner side surface of the second sidewall facing the first space.

12. The speaker box as described in claim 4, wherein the gas permeable member is provided on an inner side surface of the second sidewall facing the first space.

13. The speaker box as described in claim 5, wherein the gas permeable member is provided on an inner side surface of the second sidewall facing the first space.

14. The speaker box as described in claim 6, wherein the gas permeable member is provided on an inner side surface of the second sidewall facing the first space.

15. The speaker box as described in claim 1, wherein the second sidewall comprises a first flank wall, a second flank wall and a third flank wall, the first flank wall and the third flank wall are arranged in parallel with and apart from each other, the first sidewall comprises two slots respectively matching the first flank wall and the third flank wall, and the second flank wall connects ends of the first flank wall and the third flank wall facing away from the slots.

16. The speaker box as described in claim 1, wherein a space between the second sidewall and the top wall is sealed by a glue, a foam or a double-sided tape.

17. The speaker box as described in claim 15, wherein a space between the second sidewall and the top wall is sealed by a glue, a foam or a double-sided tape.
